(19) United States
(12) Patent Application Publication
(10) Pub. No.: US 2022/0264308 A1
(43) Pub. Date: Aug. 18, 2022

(54) WIRELESS TERMINAL DETECTION SYSTEM, WIRELESS TERMINAL DETECTION METHOD, AND STORAGE MEDIUM HAVING PROGRAM STORED THEREIN

(71) Applicant: NEC Corporation, Minato-ku, Tokyo (JP)

(72) Inventors: Jun SAKAI, Tokyo (JP); Masaki KITSUNEZUKA, Tokyo (JP); Taichi OHTSUJI, Tokyo (JP); Toshiki TAKEUCHI, Tokyo (JP); Shoji NISHIMURA, Tokyo (JP); Yasufumi HIRAKAWA, Tokyo (JP)

(73) Assignee: NEC Corporation, Minato-ku, Tokyo (JP)

(21) Appl. No.: 17/625,420

(22) PCT Filed: Jul. 10, 2020
(86) PCT No.: PCT/JP2020/027064

§ 371 Date: Jan. 7, 2022

(30) Foreign Application Priority Data
Jul. 12, 2019 (JP) 2019-130410

(51) Int. Cl. H04W 12/122; H04W 12/63; H04W 24/10; H04W 12/69

(52) U.S. Cl. CPC H04W 12/122; H04W 12/69; H04W 24/10; H04W 12/63

(57) ABSTRACT

A wireless terminal detection system provided with a radio wave identification unit that extracts identification information in accordance with the wireless terminals that are transmission sources; a radio wave intensity measurement unit that measures radio wave intensities of the radio waves; a distance estimation unit that estimates an attenuation rate of the radio wave intensities with respect to distance based on a number of the wireless terminals, and that estimates distances to the individual wireless terminals based on the estimated attenuation rate; and a notification unit that notifies a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

### TECHNICAL FIELD

The present invention relates to a wireless terminal detection system, a wireless terminal detection method, and a storage medium for storing a program.

### BACKGROUND ART

Patent Document 1 describes a mobile phone position information managing system for providing a notification that a specific person, such as a stalker who is carrying out harassing activity, has approached to within a certain distance from oneself. With this mobile phone position information managing system, by registering the mobile phone of a person whom the user of a mobile phone does not want to approach within a certain distance in an address book, information regarding the mobile phone of that person is registered in a server. When the registered mobile phone and the mobile phone in which the registration was performed approach to within a certain predetermined distance, a notification is sent from the server to the mobile phone in which the registration was performed.

Additionally, Patent Document 2 describes a wireless communication terminal that computes the distance from another wireless communication terminal in an ad-hoc wireless network lacking a base station. This wireless communication terminal converts the radio wave intensity between the wireless communication terminals to the distance between the wireless communication terminals.

Additionally, Patent Document 3 describes a suspicious person surveillance and identification method that, under states in which people carrying ID cards and a suspicious person not carrying an ID card are mingled, an array antenna is used to estimate the directions of arrival of radio waves from the ID cards in order to identify the suspicious person not carrying an ID card.

### CITATION LIST

### Patent Literature

### [Patent Document 1]

Japanese Unexamined Patent Application, First Publication No. 2006-093786

### [Patent Document 2]

Japanese Unexamined Patent Application, First Publication No. 2004-015147

### [Patent Document 3]

Japanese Unexamined Patent Application, First Publication No. 2008-067291

### SUMMARY OF THE INVENTION

### Problems to be Solved by the Invention

However, under states in which radio waves from many wireless terminals (radio wave sources, transmission sources) are detected in a mingled manner, it was difficult to accurately estimate the distance to a wireless terminal (radio wave source, transmission source) to be detected.

The present invention has an example of a purpose of providing a wireless terminal detection system, a wireless terminal detection method, and a storage medium storing a program that can solve the above-mentioned problem.

### Means for Solving the Problems

According to a first aspect of the present invention, a wireless terminal detection system is provided with a radio wave identification unit that extracts, from radio waves from individual wireless terminals detected from among received radio waves, identification information in accordance with the wireless terminals that are transmission sources; a radio wave intensity measurement unit that measures radio wave intensities of the radio waves from the individual wireless terminals; a distance estimation unit that estimates an attenuation rate of the radio wave intensities with respect to distance based on a number of the wireless terminals that are radio wave transmission sources detected from among the received radio waves, and that estimates distances to the individual wireless terminals based on the estimated attenuation rate; and a notification unit that notifies a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

According to a second aspect of the present invention, a wireless terminal detection method involves extracting, from radio waves from individual wireless terminals detected from among received radio waves, identification information in accordance with the wireless terminals that are transmission sources; measuring radio wave intensities of the radio waves from the individual wireless terminals; estimating an attenuation rate of the radio wave intensities with respect to distance based on a number of the wireless terminals that are radio wave transmission sources detected from among the received radio waves, and estimating distances to the individual wireless terminals based on the estimated attenuation rate; and notifying a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

According to a third aspect of the present invention, a program stored on a storage medium makes a computer execute processes for extracting, from radio waves from individual wireless terminals detected from among received radio waves, identification information in accordance with the wireless terminals that are transmission sources; measuring radio wave intensities of the radio waves from the individual wireless terminals; estimating an attenuation rate of the radio wave intensities with respect to distance based on a number of the wireless terminals that are radio wave transmission sources detected from among the received radio waves, and estimating distances to the individual wireless terminals based on the estimated attenuation rate; and notifying a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

### Advantageous Effects of Invention

According to this invention, when estimating the distance to a wireless terminal to be detected, the distance to the wireless terminal to be detected can be more accurately estimated by reflecting the states in the environs of the distance being estimated.

### BRIEF DESCRIPTION OF THE DRAWINGS

FIG. 1 is a schematic block diagram indicating an example of the functional configuration of a mobile terminal device according to the first embodiment.

FIG. 2 is a diagram indicating an example of attenuation of radio waves.

FIG. 3 is a diagram indicating an example of input and output of data in the respective units in the mobile terminal device according to the first embodiment.

FIG. 4 is a flow chart indicating an example of a procedure in a process for the mobile terminal device according to the first embodiment to register information regarding a mobile terminal device that is a radio wave signal source.

FIG. 5 is a flow chart indicating an example of a procedure in a process for the mobile terminal device according to the first embodiment to notify a user that a suspicious terminal has been detected.

FIG. 6 is a schematic block diagram indicating an example of the functional configuration of a mobile terminal device according to a second embodiment.

FIG. 7 is a diagram indicating an example of input and output of data in the respective units in the mobile terminal device according to the second embodiment.

FIG. 8 is a schematic block diagram indicating an example of the functional configuration of a mobile terminal device according to a third embodiment.

FIG. 9 is a diagram indicating an example of input and output of data in the respective units in the mobile terminal device according to the third embodiment.

FIG. 10 is a diagram indicating an example of the configuration of a wireless terminal detection system according to an embodiment.

FIG. 11 is a diagram indicating an example of a processing procedure in a wireless terminal detection method according to an embodiment.

FIG. 12 is a diagram indicating an example of the configuration of a wireless terminal detection device according to an embodiment.

FIG. 13 is a schematic block diagram indicating the configuration of a computer according to at least one embodiment.

### EXAMPLE EMBODIMENT

Hereinafter, embodiments of the present invention will be described. However, the embodiments below do not limit the invention according to the claims. Additionally, the entire combinations of the characteristics described in the embodiments are not necessarily essential to the solution to the invention.

### First Embodiment

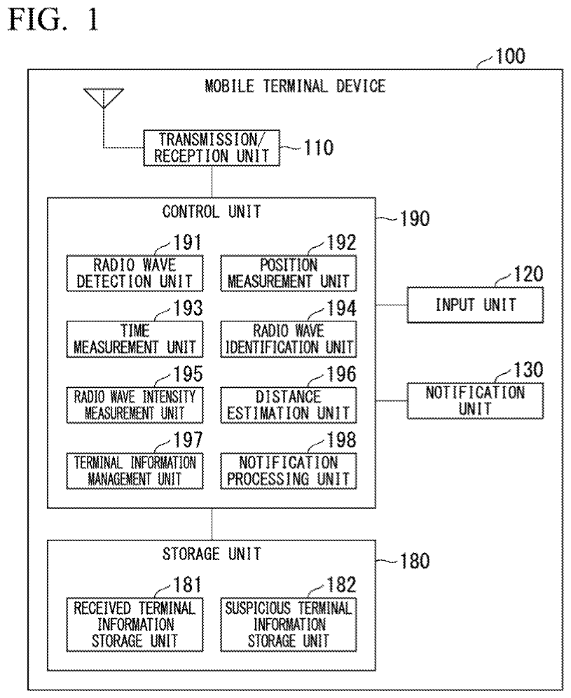

FIG. 1 is a schematic block diagram indicating an example of the functional configuration of a mobile terminal device according to the first embodiment. In the configuration indicated in FIG. 1, a mobile terminal device 100 comprises a transmission/reception unit 110, an input unit 120, a notification unit 130, a storage unit 180, and a control unit 190. The storage unit 180 comprises a received terminal information storage unit 181 and a suspicious terminal information storage unit 182. The control unit 190 comprises a radio wave detection unit 191, a position measurement unit 192, a time measurement unit 193, a radio wave identification unit 194, a radio wave intensity measurement unit 195, a distance estimation unit 196, a terminal information management unit 197, and a notification processing unit 198.

The mobile terminal device mentioned here is a mobile phone (a communication device that communicatively connects to a mobile phone network provided by a mobile phone company) such as a smartphone.

The mobile phone device 100 corresponds to an example of a wireless terminal detection system. However, the configuration of the wireless terminal detection system according to the embodiment is not limited to being a configuration based on a mobile terminal device, and various configurations that are capable of receiving radio waves may be used. For example, the wireless terminal detection system may be configured as a device dedicated to wireless terminal detection. Additionally, the wireless terminal detection system may be configured by combining a plurality of devices. The wireless terminal detection system may also be referred to as a wireless terminal detection device. Additionally, the wireless terminal may be referred to as a wireless device, a wireless device, a mobile terminal, a mobile terminal device, a mobile phone, or the like.

Additionally, hereinafter, the case in which the mobile terminal device 100 detects a mobile terminal device as an example of the wireless terminal will be explained. However, the wireless terminal that is to be detected by the wireless terminal detection device or the wireless terminal detection system is not limited to being a mobile terminal device. Various types of device that generate radio waves (for example, transmission sources such as concealed listening devices or concealed camera devices having signal generation functions) may be detected.

Upon detecting a mobile terminal device that is a notification-triggering target within a prescribed distance, the mobile terminal device 100 notifies a user that the notification-triggering target has been detected. For example, when a mobile terminal device 100 carried by a victim of stalking activity detects a suspicious (suspect) mobile terminal device (hereinafter referred to simply as a suspicious terminal) that has a possibility of being a mobile terminal device carried by the stalker, the user (the victim of the stalking activity) is notified. The user who has received the notification can then increase vigilance towards the stalker and take measures such as by leaving the area if needed. The mobile terminal device 100 can similarly be used against harmful activity that has a possibility of recurring other than stalking activity, such as groping activity. A mobile terminal device carried by a stalker will also be referred to as the stalker's mobile terminal device.

The mobile terminal device 100 detects the radio waves from individual transmitters (mobile terminal devices that are the radio wave transmission sources) from among radio waves that are received (hereinafter referred to as received radio waves). Furthermore, the mobile terminal device 100 extracts identification information capable of identifying the transmitter, from the radio waves from the individual transmitters that have been detected. As will be described below, as for the identification information in this case, characteristic amounts indicating characteristics occurring in radio waves due to analog properties or the like of hardware in the transmitters, may be used. In particular, identification information can be extracted even when the mobile terminal device 100 cannot decode a received signal. The radio wave transmission sources will also be referred to simply as transmission sources.

When an incident occurs such as being subjected to stalking activity, the user inputs the fact that the incident occurred in the input unit 120, then the mobile terminal device 100 registers identification information extracted from the radio waves received at that time as identification information for a suspicious terminal.

Hereinafter, a mobile terminal device that has a possibility of being a user notification-triggering target, such as the stalker's mobile terminal device, will be treated as a suspicious terminal. Additionally, the incident mentioned here is an incident occurring under circumstances in which the mobile terminal device 100 can be expected to be receiving radio waves from the suspicious terminal. For example, if an incident in which the user is being followed by a stalker is occurring, then the mobile terminal device 100 can be expected to be receiving radio waves from the stalker's mobile terminal device due to the stalker being positioned near the user.

After the identification information of the suspicious terminal has been registered, when the suspicious terminal whose identification information has been registered is detected as being positioned within a prescribed distance from the mobile terminal device 100, the mobile terminal device 100 notifies the user that the suspicious terminal has been detected.

The mobile terminal device 100 estimates the distance to another mobile terminal device, such as the suspicious terminal, based on the reception intensity of radio waves from that mobile terminal device.

The transmission/reception unit 110 is configured so as to include an antenna, an amplifier, and a demodulator, and communicates with other devices. In particular, the transmission/reception unit 110 receives signals transmitted by other mobile terminal devices that are to be detected.

The notification unit 130 provides various types of notifications to the user. In particular, the notification unit 130 notifies the user that a suspicious terminal has been detected in the case in which, based on the identification information extracted from the radio waves from individual mobile terminal devices, the following determination is made. Specifically, the notification unit 130 notifies the user that a suspicious terminal has been detected in the case in which a mobile terminal device that is the radio wave transmission source is determined to be registered as a suspicious terminal, and the estimated distance to the mobile terminal device that is the radio wave transmission source is determined to be not more than a prescribed distance.

For example, the notification unit 130 may comprise a display screen such as a liquid crystal display panel or an LED (Light-Emitting Diode) panel, and may notify the user with a screen display, such as by displaying a message.

However, the method for notification by the notification unit 130 is not limited to a method due to the screen display. For example, the notification unit 130 may comprise a speaker, and may provide a notification by audio output in addition to or instead of a screen display.

The notification unit 130 may notify the user of the estimated distance to the suspicious terminal in addition to the fact that the suspicious terminal has been detected. The user can increase vigilance as the estimated distance to the suspicious terminal becomes shorter. For example, if the estimated distance to the suspicious terminal is a few meters, then the user can be made aware that there is a high likelihood that a suspicious person such as a stalker is very close to the user, and can immediately take measures such as by leaving the area.

Additionally, the notification unit 130 may notify the user of history information regarding past detection of that suspicious terminal in addition to the fact that the suspicious terminal has been detected. The user can refer to the history information and be made aware of the likelihood that the detected suspicious terminal actually is the mobile terminal device of a harasser and of the frequency of harassment activity.

For example, in the case of stalking activity, if the mobile terminal device 100 detects the suspicious terminal many times, then the user can be made aware that there is a high likelihood that the suspicious terminal actually is the stalker's mobile terminal device, and that stalking activity, such as persistent following, is frequently occurring, and thus increase vigilance.

The input unit 120 receives notifications from the user. In particular, the input unit 120 receives notifications indicating that incidents have occurred. The input unit 120, for example, comprises an input device such as a touch sensor constituting a touch panel provided in the display screen of the notification unit 130, and receives notifications from the user by means of user operations.

The storage unit 180 stores various types of data. The storage unit 180 is constituted by a storage device provided in the mobile terminal device 100.

The received terminal information storage unit 181 stores received terminal information. The received terminal information storage unit 181 may store, as the received terminal information, information combining identification information extracted from radio waves and information regarding the reception date/time and reception position of those radio waves.

The storage of received terminal information by the received terminal information storage unit 181 may, for example, be temporary, such as for one hour after registration. By the received terminal information storage unit 181 storing the received terminal information, if there is a notification by the user, suspicious terminals can be found by looking farther into the past than the notification timing.

The suspicious terminal information storage unit 182 stores suspicious terminal information. Suspicious terminal information is received terminal information relating to suspicious terminals.

The control unit 190 controls the units in the mobile terminal device 100 to perform various types of processes. The functions of the control unit 190 are executed by a CPU (Central Processing Unit) provided in the mobile terminal device 100 reading a program from the storage unit 180 and executing the program.

The radio wave detection unit 191 detects the radio waves of each mobile terminal device among the radio waves received by the transmission/reception unit 110.

For example, in the case of a Wi-Fi (registered trademark) terminal, a probe request signal for searching for access points in the environs is periodically transmitted. Therefore, the probe request signals can be used as the radio waves to be detected by the radio wave detection unit 191.

Additionally, in the case of terminals for mobile communication lines such as 3G (third-generation mobile communication systems) or LTE (registered trademark, Long Term Evolution), signals for searching for base stations can similarly be used as the radio waves to be detected by the radio wave detection unit 191.

Additionally, for either type of terminal, radio waves transmitted by the terminals when executing a mail program, a web browser, an SNS (Social Networking Service), or an app (application program) can be used as the radio waves to be detected by the radio wave detection unit 191.

The position measurement unit 192 measures the current position of the user's mobile terminal device 100 and acquires position information. The user's mobile terminal device 100 mentioned here is the mobile terminal device 100 comprising the measurement unit measuring the current position itself. In the case of the position measurement unit 192, the user's mobile terminal device 100 is the mobile terminal device 100 comprising the position measurement unit 192 itself.

The method by which the position measurement unit 192 acquires the position information is not limited to a specific method. For example, the position measurement unit 192 may comprise a GNSS (Global Navigation Satellite System) terminal device and may perform positioning by using signals from the GNSS terminal device (satellite). Alternatively, the position measurement unit 192 may utilize a position estimation system using Wi-Fi (registered trademark) access points, Bluetooth (registered trademark) beacons, or the like.

The time measurement unit 193 is configured as a clock and computes the current time.

The radio wave identification unit 194 extracts, from the radio waves of individual mobile terminal devices detected by the radio wave detection unit 191 from among the radio waves received by the transmission/reception unit 110, identification information corresponding to the mobile terminal information of transmission sources.

For example, in the case of Wi-Fi (registered trademark) communication, the transmitted signals include the MAC addresses (Media Access Control addresses) of the transmitting terminals. The radio wave identification unit 194 may use these MAC addresses as the identification information.

Additionally, for arbitrary wireless terminals, the characteristics of each wireless terminal are included in the transmitted signals due to analog properties of the hardware and the like. Therefore, the radio wave identification unit 194 may measure and save time-series data of the radio waves from individual wireless terminals, and may extract characteristic amounts indicating the characteristics of each wireless terminal as the identification information. Furthermore, the mobile terminal device 100 may use extracted characteristic amounts to determine whether or not the transmission source of multiple radio waves is the same wireless terminal.

Alternatively, the radio wave identification unit 194 may extract the time-series data of radio waves from individual wireless terminals themselves as the identification information. In this case, the mobile terminal device 100 may acquire correlations between the time-series data of radio waves from the individual wireless terminals to determine whether or not the transmission source of multiple radio waves is the same wireless terminal.

The radio wave intensity measurement unit 195 measures the intensities of the radio waves from the individual mobile terminal devices detected by the radio wave detection 191 from among the radio waves received by the transmission/reception unit 110.

The distance estimation unit 196 estimates the distances to the mobile terminal devices that are the transmission sources based on the radio wave intensities measured by the radio wave intensity measurement unit 195. In particular, the distance estimation unit 196 estimates the attenuation rate of the radio wave intensities with respect to distance based on the number of mobile terminal devices that are radio wave transmission sources detected from among the radio waves received by the transmission/reception unit 110. Furthermore, the distance estimation unit 196 uses the estimated attenuation rate to estimate the distances to the individual mobile terminal devices that are radio wave transmission sources. The number of mobile terminal devices that are radio wave transmission sources detected from among the radio waves received by the transmission/reception unit 110 is indicated by the number of items of identification information extracted by the radio wave identification unit 194 from among the radio waves from the individual mobile terminal devices.

Generally, as the propagation distance from a radio wave signal source to a receiving terminal becomes longer, the reception power becomes smaller due to propagation loss. The relationship between propagation distance d and reception power P_{RX} is indicated by Expression (1).

P_{RX}=−a log(d)*b [Mathematical Expression 1]

The value “a” in Expression (1) indicates the proportional increase in loss (attenuation rate) with respect to the increase in distance. The value “b” in Expression (1) represents the reception power at a certain distance (for example, 1 meter (m)) from the radio wave signal source.

The radio wave attenuation rate becomes larger when there are many radio wave absorbers such as obstacles and people.

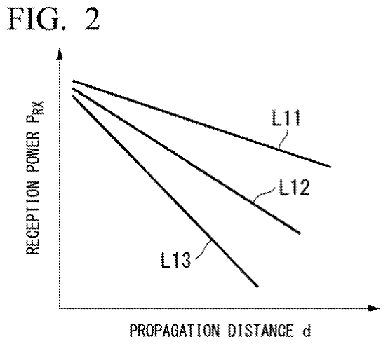

FIG. 2 is a diagram indicating an example of the attenuation of radio waves. The horizontal axis of the graph in FIG. 2 indicates the propagation distance d. The vertical axis indicates the reception power P_{RX}.

The line L11 indicates an example of the relationship between the propagation distance d and the reception power P_{RX} in the case where there are relatively few people positioned in the environs of the mobile terminal device 100. The line L12 indicates an example of the relationship between the propagation distance d and the reception power P_{RX} in the case where there are more people positioned in the environs of the mobile terminal device 100 than in the case of the line L11. The line L13 indicates an example of the relationship between the propagation distance d and the reception power P_{RX} in the case where there are even more people positioned in the environs of the mobile terminal device 100 than in the case of the line L12.

Comparing the line L11 and the line L12, the degree of decrease in the reception power P_{RX} with respect to the increase in the propagation distance d is greater for the line L12. Furthermore, comparing the line L12 and the line L13, the degree of decrease in the reception power P_{RX} with respect to the increase in the propagation distance d is greater for the line L13.

Therefore, in the example in FIG. 2, the attenuation rate becomes greater as more people are positioned in the environs of the mobile terminal device 100. In other words, the more people are positioned in the environs of the mobile terminal device 100, the higher the rate of increase in loss with respect to the increase in distance from the mobile terminal device 100.

The larger the number of radio waves from individual mobile terminal devices detected by the radio wave detection unit 191, the greater the number of people positioned in the environs of the mobile terminal device 100 can be inferred to be. Accordingly, the greater the number of radio waves from individual mobile terminal devices detected by the radio wave detection unit 191, the higher the radio wave attenuation rate can be inferred to be. Therefore, the distance estimation unit 196 may compute the attenuation rate “a” by using Expression (2).

### [Mathematical Expression 2]

a=f(n),

f(n)=k₁n²k₂n+k₃\sqrt{n}+k₄ (2)

The value “n” in Expression (2) indicates the number of radio waves from individual mobile terminal devices detected by the radio wave detection unit 191.

k₁, k₂, k₃, and k₄ are all coefficients. For example, experiments may be performed in advance to determine the values of k₁, k₂, k₃, and k₄.

Alternatively, the distance estimation unit 196 may further compute the attenuation rate based on the intensity of the radio waves. The more radio waves with strong intensity there are among the radio waves from the individual mobile terminal devices detected by the radio wave detection unit 191, the more people can be inferred to be positioned near the mobile terminal device 100. In contrast therewith, the more radio waves with weak intensity there are among the radio waves from the individual mobile terminal devices detected by the radio wave detection unit 191, the more people can be inferred to be positioned relatively far from the mobile terminal device 100.

The absorption and attenuation of radio waves is due to people and obstacles on the propagation path from a mobile terminal device that is a radio wave transmission source to the mobile terminal device 100. In the case in which there are many people positioned near the mobile terminal device 100, there is a relatively high likelihood that at least some of those people are positioned on the propagation path and thus will absorb and attenuate the radio waves that are to be used for measuring distance. In contrast therewith, in the case in which there are many people positioned relatively far from the mobile terminal device 100, there is a relatively high likelihood that these people are not positioned on the propagation path and will not affect absorption or attenuation of the radio waves.

Therefore, the distance estimation unit 196 may compute the attenuation rate to be greater, the more radio waves with strong intensity there are. For example, the distance estimation unit 196 may compute the attenuation rate “a” by using Expression (3).

### [Mathematical Expression 3]

a=∫g(P)NₚdP,

g(P)=h₁P²+h₂P+h₄\sqrt{P}+h₄ (3)

In this case, it is assumed that n radio waves (radio waves from n radio wave transmission sources) are detected, and that the respective radio wave intensities thereof are P₁, P₂, . . . , Pₙ. Additionally, N_{P} indicates the number of radio wave intensities that are included in the section in Expression (4) among the radio wave intensities Pᵢ (i=1, 2, . . . , n).

$$\begin{matrix}[ Mathematical Expression 4 ] & \\ P - \frac{Δ P}{2} < {P}_{i} < P + \frac{Δ P}{2} & ( 4 )\end{matrix}$$

The value “P” in Expressions (3) and (4) indicates radio wave intensity, and is integrated, as indicated in Expression (3). For example, in Expression (4), ΔP is set to be a small value and the radio wave intensities are divided into small section widths. In Expression (3), the integral calculation can be approximated by calculating and summing g(P)N_{P} for each radio wave intensity section.

The values h₁, h₂, h₃, and h₄ in Expression (3) are all coefficients. For example, experiments may be performed in advance to determine the values of h₁, h₂, h₃, and h₄.

The terminal information management unit 197 writes and reads data with respect to each of the reception terminal information storage unit 181 and the suspicious terminal information storage unit 182. In particular, the terminal information management unit 197 stores, in the received terminal information storage unit 181, as the received terminal information, the information relating to the radio waves from the individual mobile terminal devices, detected by the radio wave detection unit 191 from among the radio waves received by the transmission/reception unit 110. For example, the terminal information management unit 197 stores, in the received terminal information storage unit 181, as the received terminal information, the identification information, the reception dates/times, the reception positions, and the estimated distances to the mobile terminal devices that are the transmission sources, extracted from the radio waves by the radio wave identification unit 194 regarding the radio waves from the individual mobile terminal devices.

Additionally, the terminal information management unit 197 acquires information regarding the radio waves from the individual mobile terminal devices detected by the radio wave detection unit 191 from the radio waves received by the transmission/reception unit 110 when the input unit 120 has received a notification from the user indicating that an incident has occurred. The terminal information management unit 197 stores, in the suspicious terminal information storage unit 182, as suspicious terminal information, information regarding the radio waves from the individual mobile terminal devices that have been acquired. For example, as in the case of the received terminal information, the terminal information management unit 197 stores, in the suspicious terminal information storage unit 182, as suspicious terminal information, the identification information, the reception dates/times, the reception positions, and the estimated distances to the mobile terminal devices that are the transmission sources, extracted from the radio waves by the radio wave identification unit 194.

In this case, the timing at which the user provides a notification indicating that an incident has occurred will not always be the same as the timing at which the mobile terminal device of a suspicious person such as a stalker periodically transmits radio waves. Therefore, the terminal information management unit 197 acquires information regarding the radio waves from individual mobile devices detected by the radio wave detection unit 191 from among the radio waves received by the transmission/reception unit 110 within a prescribed time period before and after the input unit 120 received the notification from the user indicating that the incident occurred. The terminal information management unit 197 stores, in the suspicious terminal information storage unit 182, as suspicious terminal information, the information regarding the radio waves from the individual mobile terminal devices that has been acquired.

For example, the terminal information management unit 197 may acquire information regarding radio waves from the individual mobile terminal devices detected by the radio wave detection unit 191, based on the radio waves received thereby, for the radio waves received by the transmission/reception unit 110 within one hour after the input unit 120 received a notification from the user indicating that an incident occurred. The terminal information management unit 197 stores, in the suspicious terminal information storage unit 182, as suspicious terminal information, the information regarding the radio waves from said individual mobile terminal devices that has been acquired. Alternatively, after the input unit 120 has received a notification from the user indicating that an incident has occurred, the terminal information management unit 197 may acquire information regarding the radio waves from each mobile terminal device detected by the radio wave detection unit 191 from the radio waves received by the transmission/reception unit 110 within that day. The terminal information management unit 197 may store, in the suspicious terminal information storage unit 182, as suspicious terminal information, the information regarding the radio waves from each of said mobile terminal devices that has been acquired.

Alternatively, in the case in which the user cannot immediately provide a notification when an incident has occurred, the user may provide, as a notification to the mobile terminal device 100 after the incident occurred, the timing at which the incident occurred, such as the time of day at which the incident occurred or how many minutes before the notification the incident occurred. In this case, the terminal information management unit 197 acquires suspicious terminal information by using the incident occurrence timing designated by the user as a reference, and stores the suspicious terminal information in the suspicious terminal information storage unit 182.

The terminal information management unit 197 may store, in the suspicious terminal information storage unit 182, as suspicious terminal information, information regarding the radio waves from each and every mobile terminal device detected within a certain time period. In this case, the mobile terminal device 100 may treat mobile terminal devices that were at shorter estimated distances at the time of occurrence of the incident or at times proximate thereto as having a high probability of being the mobile terminal device of the suspicious person. For example, if the radio wave identification unit 194 re-identifies radio waves from a mobile terminal device that has been registered as suspicious terminal information, then the notification unit 130 may notify the user that a suspicious terminal has been detected only when the probability for that mobile terminal device is a prescribed value or higher.

Alternatively, the terminal information management unit 197 may store, in the suspicious terminal information storage unit 182, as suspicious terminal information, information regarding radio waves having the shortest estimated distance (therefore, those estimated to be from a source to the closest to the user), among the radio waves from each of the mobile terminal devices. Alternatively, the terminal information management unit 197 may store, in the suspicious terminal information storage unit 182, as suspicious terminal information, information regarding radio waves from all mobile terminal devices having an estimated distance that is a prescribed distance or less, among the radio waves from each of the mobile terminal devices.

The terminal information management unit 197 may store, in the suspicious terminal information storage unit 182, suspicious terminal information including the position and the time at which the suspicious terminal started being detected. Specifically, in the case in which radio waves from the same mobile terminal device are repeatedly detected, the terminal information management unit 197 may store, in the suspicious terminal information storage unit 182, information regarding the time and the position at which the radio waves were first detected among the repeated instances.

For example, if the user is riding a train and the position at which the radio waves were first detected is a station, then the suspicious person can be considered to have boarded the train at that station. By obtaining information regarding the activity patterns of the suspicious person, the user can contemplate measures to use against the suspicious person. For example, the user could take the measure of using a train on another line for the section over which the suspicious person uses the train.

Additionally, the terminal information management unit 197 may store, in the suspicious terminal information storage unit 182, suspicious terminal information including the position and the time at which the suspicious terminal stopped being detected. Specifically, if radio waves from the same mobile terminal device are repeatedly detected and then stop being detected thereafter, then the terminal information management unit 197 may store, in the suspicious terminal information storage unit 182, information regarding the time and the position at which the radio waves were last detected from among the repeated instances.

For example, if the user is riding a train and the position at which the radio waves were last detected is a station, then the suspicious person can be considered to have disembarked from the train at that station. By obtaining information regarding the activity patterns of the suspicious person, the user can contemplate measures to use against the suspicious person. For example, the user could take the measure of using a train on another line for the section over which the suspicious person uses the train.

The notification processing unit 198 controls the notification unit 130 to provide notifications to the user. For example, if the radio wave identification unit 194 has detected radio waves from a suspicious terminal that is registered in the suspicious terminal information storage unit 182, then the notification processing unit 198 controls the notification unit 130 to provide a notification that a suspicious terminal has been detected.

When determining whether or not a suspicious terminal has been detected, the notification processing unit 198 may compute the similarity between the identification information extracted by the radio wave identification unit 194 from the radio waves from the mobile terminal device detected by the radio wave detection unit 191 and the identification information indicated in the suspicious terminal information. Then, the notification processing unit 198 may determine that a suspicious terminal has been detected in the case in which a degree of similarity higher than a prescribed threshold value.

For example, in the case in which a MAC address is used as the identification information, if there is a complete match of the 12-digit MAC address, then the notification unit 198 may determine that a suspicious terminal has been detected.

Alternatively, in the case in which a characteristic amount in the radio waves other than a MAC address is used as the identification information, the notification processing unit 198 may compute the degree of similarity with the characteristic amount or a correlation value as a numerical value, and may determine that a suspicious terminal has been detected if the computed numerical value is greater than a prescribed threshold value.

If it is determined that a suspicious terminal has been detected, then the notification processing unit 198 controls the notification unit 130 to notify the user that a suspicious terminal has been detected. Additionally, the notification processing unit 198 may control the notification unit 130 to notify the user of the estimated distance to the suspicious terminal. Alternatively, the notification processing unit 198 may control the notification unit 130 to notify the user by a stepped display of the proximity of the suspicious terminal in addition to or instead of adding the estimated distance, or may instead. In this case, the stepped display of the proximity of the suspicious terminal is not limited to being a specific number of steps. The stepped display of the proximity of the suspicious terminal may, for example, consist of the three steps “near”, “intermediate”, and “far”. The stepped display of the proximity of the suspicious terminal may, for example, consist of the five steps “very near”, “near”, “intermediate”, “far”, or “very far”.

The notification processing unit 198 may control the notification unit 130 so as to notify the user of detection history information of a suspicious terminal in addition to providing notification that the suspicious terminal has been detected. For example, the notification processing unit 198 may acquire, from the received terminal information storage unit 181, via the terminal information management unit 197, the mobile information terminal information of that suspicious terminal, and may notify the user by means of the notification unit 130 (for example, by displaying a notification on the notification unit 130).

Additionally, the notification processing unit 198 may control the notification unit 130 to notify the user of the position and the time at which a suspicious terminal started being detected in addition to the fact that the suspicious terminal was detected. Additionally, the notification processing unit 198 may control the notification unit 130 to notify the user of the position and the time at which a suspicious terminal stopped being detected in addition to the fact that the suspicious terminal was detected.

The notification processing unit 198 may switch the categories of notifications to the user to be provided by the notification unit 130 in accordance with a request from the user.

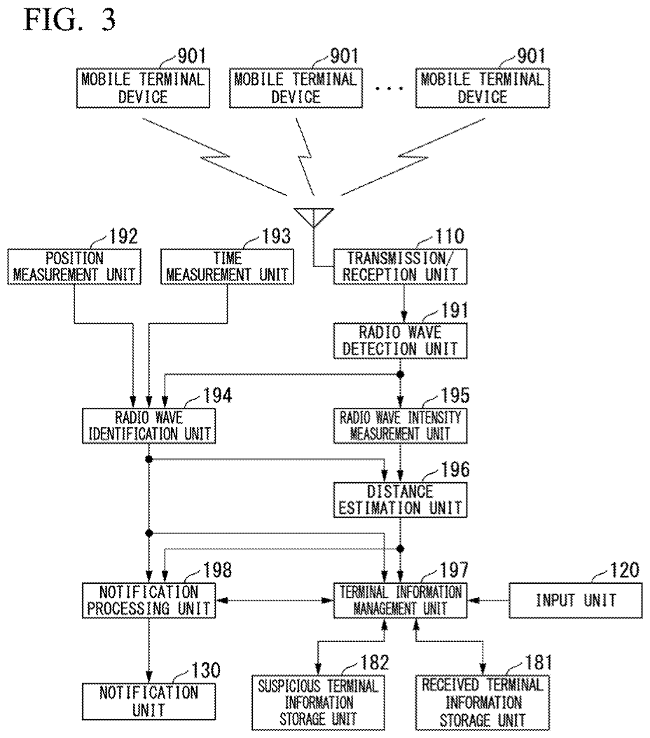

FIG. 3 is a diagram indicating an example of the input and output of data in the units in the mobile terminal device 100.

In the example in FIG. 3, the transmission/reception unit 110 receives radio waves transmitted by mobile terminal devices 901. The transmission/reception unit 110 outputs reception signals indicating the received radio waves to the radio wave detection unit 191.

The radio wave detection unit 191 detects the radio waves from the individual mobile terminal devices 901 from among the radio waves received by the transmission/reception unit 110. The radio wave detection unit 191 outputs reception signals indicating the detected radio waves to the radio wave identification unit 194 and the radio wave intensity measurement unit 195.

The radio wave intensity measurement unit 195 measures the radio wave intensities (reception signal intensities) of the radio waves from the individual mobile terminal devices 901 detected by the radio wave detection unit 191. The radio wave intensity measurement unit 195 outputs the measured radio wave intensities to the distance estimation unit 196.

Additionally, the position measurement unit 192 measures the current position of the user's mobile terminal device 100 and outputs the obtained position information to the radio wave identification unit 194. The time measurement unit 193 computes the current time and outputs the current time that has been computed to the radio wave identification unit 194.

The radio wave identification unit 194 extracts identification information from the radio waves from the individual mobile terminal devices 901 detected by the radio wave detection unit 191. The radio wave identification unit 194 outputs, to the terminal information management unit 197 and the notification processing unit 198, information in which identification information extracted from the radio waves is combined with position information (current position of the mobile terminal device 100) from the position measurement unit 192 and the time information (current time). Additionally, the radio wave identification unit 194 also outputs identification information extracted from the radio waves to the distance estimation unit 196.

In the information output by the radio wave identification unit 194 to the terminal information management unit 197 and the notification processing unit 198, the position information (current position of the mobile terminal device 100) indicates the reception position of the radio waves. Additionally, the time information (current time) indicates the reception time of the radio waves.

The distance estimation unit 196 estimates the distances to the mobile terminal devices 901 that are the radio wave transmission sources based on the radio wave intensities from the radio wave intensity measurement unit 195. The distance estimation unit 196 associates the identification information from the radio wave identification unit 194 with the estimated distances and outputs the information to the terminal information management unit 197 and the notification processing unit 198.

The terminal information management unit 197 stores, in the received terminal information storage unit 181, as received terminal information, information obtained by further adding, to the identification information, the position information, and the time information from the radio wave identification unit 194, the estimated distances from the distance estimation unit 196 associated with the identification information.

Additionally, when the input unit 120 has received a notification that an incident has occurred from the user, the terminal information management unit 197 also stores, in the suspicious terminal information storage unit 182, as suspicious terminal information, the information obtained by further adding, to the identification information, the position information, and the time information from the radio wave identification unit 194, the estimated distances from the distance estimation unit 196 associated with the identification information, for a prescribed time period before and after the occurrence of the incident.

The notification processing unit 198 acquires suspicious terminal information from the suspicious terminal information storage unit 182 via the terminal information management unit 197, and compares the identification information from the radio wave identification unit 194 with the identification information of the suspicious terminal information. As a result thereof, the notification processing unit 198 determines whether or not the radio waves from the individual mobile terminal devices 901 detected by the radio wave detection unit 191 are radio waves from suspicious terminals. If radio waves from the individual mobile terminal devices 901 detected by the radio wave detection unit 191 are determined to be radio waves from a suspicious terminal, then the notification processing unit 198 controls the notification unit 130 to notify a user that a suspicious terminal has been detected. When doing so, the notification processing unit 198 controls the notification unit 130 to notify the user of the estimated distance to that suspicious terminal in addition to the fact that the suspicious terminal has been detected.

Furthermore, the notification processing unit 198 may control the notification unit 130 so as to notify the user of detection history information for that suspicious terminal. Additionally, the notification processing unit 198 may control the notification unit 130 so as to notify the user of the position and the time at which the suspicious terminal started being detected. Additionally, the notification processing unit 198 may control the notification unit 130 so as to notify the user of the position and the time at which the suspicious terminal stopped being detected.

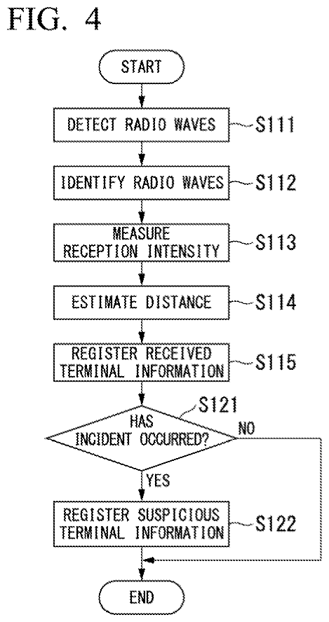

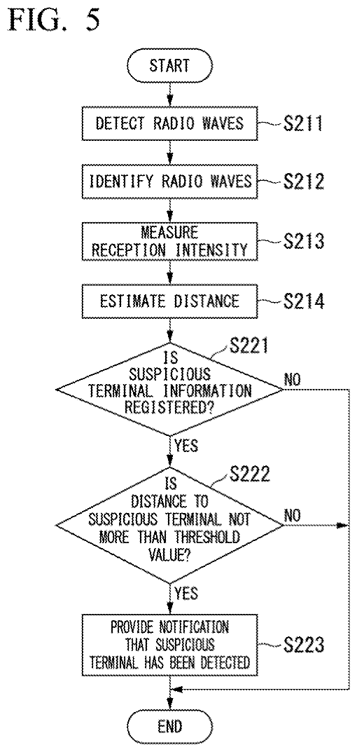

Next, the operations of the mobile terminal device 100 will be explained by referring to FIG. 4 and FIG. 5.

FIG. 4 is a flow chart indicating an example of the procedure in a process for the mobile terminal device 100 to register information regarding a mobile terminal device that is a radio wave signal source. The mobile terminal device 100 repeatedly performs the processes in FIG. 4 in order to continuously monitor the radio waves from other mobile terminal devices.

In the process in FIG. 4, the radio wave detection unit 191 detects radio waves from the individual mobile terminal devices from among the radio waves received by the transmission/reception unit 110 (step S111). The radio wave detection unit 191 outputs, to the radio wave identification unit 194 and the radio wave intensity measurement unit 195, reception signals indicating radio waves from the individual mobile terminal devices that have been detected.

The radio wave identification unit 194 extracts identification information from among the radio waves from the individual mobile terminal devices detected by the radio wave detection unit 191 (step S112). The radio wave identification unit 194 outputs, to the terminal information management unit 197, information combining the identification information that has been extracted, the position of the mobile terminal device 100 measured by the position measurement unit 192, and the current time measured by the time measurement unit 193. Additionally, the radio wave identification unit 194 outputs the extracted identification information to the distance estimation unit 196.

As will be explained below with reference to FIG. 5, the radio wave identification unit 194 also outputs the information combining the identification information that has been extracted, the position of the mobile terminal device 100 measured by the position measurement unit 192, and the current time measured by the time measurement unit 193 to the notification processing unit 198.

Additionally, the radio wave intensity measurement unit 195 measures the intensities of the radio waves from the individual mobile terminal devices detected by the radio wave detection unit 191 (step S113). The radio wave intensity measurement unit 195 outputs the measured radio wave intensities to the distance estimation unit 196.

The distance estimation unit 196 estimates the distances to the mobile terminal device that is the radio wave signal source based on the radio wave intensities measured by the radio wave intensity measurement unit 195 (step S114). The distance estimation unit 196 associates the obtained estimated distances with the identification information output from the radio wave identification unit 194, and outputs the information to the terminal information management unit 197.

As will be explained below with reference to FIG. 5, the distance estimation unit 196 also outputs, to the notification processing unit 198, the information in which the obtained estimated distances are associated with the identification information output from the radio wave identification unit 194.

The terminal information management unit 197 further combines the estimated distances associated with the identification information, output from the distance estimation unit 196, with the combination of the identification information, the position information, and the time information from the radio wave identification unit 194, and stores the information, as received terminal information, in the received terminal information storage unit 181.

Additionally, the terminal information management unit 197 determines whether or not an incident has occurred (step S121). Specifically, the terminal information management unit 197 determines whether or not the input section 120 has received a notification from the user indicating that an incident has occurred.

If it is determined that an incident has not occurred (step S121: NO), then the mobile terminal device 100 ends the process in FIG. 4.

On the other hand, if it is determined that an incident has occurred (step S121: YES), then the terminal information management unit 197 stores, in the suspicious terminal information storage unit 182, as suspicious terminal information, the information obtained by further combining the estimated distances associated with the identification information, output from the distance estimation unit 196, with the combination of the identification information, the position information, and the time information from the radio wave identification unit 194.

After step S122, the mobile terminal device ends the process in FIG. 4.

FIG. 5 is a flow chart indicating an example of the procedure in a process for the mobile terminal device 100 to notify the user that a suspicious terminal has been detected. The mobile terminal device 100 repeatedly performs the process in FIG. 5 in order to continuously monitor the radio waves from other mobile terminal devices.

The process in steps S211 to S214 in FIG. 5 is the same as the process in steps S111 to S114 in FIG. 4. The process in steps S111 to S114 in FIG. 4 is also used as the process in steps S211 to S214 in FIG. 5.

In the process in step S212, the radio wave identification unit 194 outputs, to the notification processing unit 198, the information obtained by combining the extracted identification information, the position of the user's mobile terminal device 100 measured by the position measurement unit 192, and the current time measured by the time measurement unit 193. Additionally, in the process in step S214, the distance estimation unit 196 outputs, to the notification processing unit 198, the information obtained by associating the obtained estimated distances with the identification information output from the radio wave identification unit 194.

After step S214, the notification processing unit 198 determines whether or not identification information that the radio wave identification unit 194 has extracted from the radio waves is registered in the suspicious terminal information (step S221).

If the notification processing unit 198 has determined that identification information that the radio wave identification unit 194 has extracted from the radio waves is not registered in the suspicious terminal information (step S221: NO), then the mobile terminal device 100 ends the process in FIG. 5.

On the other hand, if it is determined that identification information extracted from the radio waves by the radio wave identification unit 194 is registered in the suspicious terminal information (step S221: YES), then the notification processing unit 198 determines whether or not the distance to the suspicious terminal is not more than a prescribed threshold value (step S222). The notification processing unit 198 may further perform a determination to decide whether to notify the user that a suspicious terminal has been detected, such as that the probability of being a suspicious terminal is higher than a prescribed threshold value, as mentioned above.

If the notification processing unit 198 has determined that the distance to the suspicious terminal is greater than the threshold value (step S222: NO), then the mobile terminal device 100 ends the process in FIG. 5.

On the other hand, if it is determined that the distance to the suspicious terminal is not more than the threshold value (step S222: YES), then the notification processing unit 198 controls the notification unit 130 to notify the user that a suspicious terminal has been detected (step S223).

After step S223, the mobile terminal device 100 ends the process in FIG. 5.

As described above, the radio wave identification unit 194 extracts identification information corresponding to mobile terminal devices that are transmission sources from the radio waves from individual mobile terminal devices detected from among radio waves received by the transmission/reception unit 110. The radio wave intensity measurement unit 195 measures the intensities of the radio waves from individual mobile terminal devices. The distance estimation unit 196 estimates the attenuation rate of the radio wave intensities with respect to distance based on the number of mobile terminal devices that are radio wave transmission sources detected from among the radio waves received by the transmission/reception unit 110, and estimates the distances to the individual mobile terminal devices based on the estimated attenuation rate. In the case in which, based on the aforementioned identification information, a mobile terminal device that is the radio wave transmission source is determined to be registered as a suspicious terminal and the estimated distance to the mobile terminal device that is the radio wave transmission source is determined to be not more than a prescribed distance, the notification unit 130 notifies the user that a suspicious terminal has been detected.

As a result thereof, the mobile terminal device 100 can make the estimated distance reflect the states in the environs when estimating the distance to a mobile terminal device that is to be detected. In particular, according to the mobile terminal device 100, the estimated distance can be made to reflect the states of attenuation of radio waves due to people in the environs of the mobile terminal device 100. Due to this feature, the distance from the mobile terminal device to be detected can be estimated with higher precision.

Additionally, the distance estimation unit 196 estimates the attenuation rate based on the number of mobile terminal devices that are radio wave transmission sources detected from among the radio waves received by the transmission/reception unit 110 and the radio wave intensities of the radio waves from the individual mobile terminal devices that are radio wave transmission sources.

As a result thereof, the mobile terminal device 100 reflects, in the estimated distances, not only the number of people in the environs of the mobile terminal device 100, but also the distances from the mobile terminal device 100 to the people in the environs thereof. Due to this feature, the distance from the mobile terminal device to be detected can be estimated with higher precision.

Additionally, the notification unit 130 notifies the user that a suspicious terminal has been detected, and the estimated distance to that suspicious terminal.

The user can increase vigilance as the estimated distance to the suspicious terminal becomes shorter. For example, if the estimated distance to the suspicious terminal is a few meters, then the user can be made aware that there is a high likelihood that a suspicious person such as a stalker is very close to the user, and can immediately take measures such as by leaving the area.

Additionally, the notification unit 130 notifies the user that a suspicious terminal has been detected and history information in which the suspicious terminal has been detected in the past.

The user can refer to the history information and be made aware of the possibility that the detected suspicious terminal is actually the mobile terminal device of the harasser and of the frequency of harassment activity.

For example, in the case of stalking activity, if the mobile terminal device 100 detects the suspicious terminal many times, then the user can be made aware that there is a high likelihood that the suspicious terminal actually is the stalker's mobile terminal device, and that stalking activity, such as persistent following, is frequently occurring, and thus increase vigilance.

Additionally, the suspicious terminal information storage unit 182 stores the position and the time at which a suspicious terminal started being detected.

A user can refer to the position and the time at which the suspicious terminal started being detected and thereby obtain information regarding activity patterns of the suspicious person, allowing the contemplation of measures to be taken against the suspicious person. For example, if the user is riding a train and the position at which the radio waves were first detected is a station, then the suspicious person can be considered to have boarded the train at that station. In this case, the user can take the measure of using a train on another line for the section over which the suspicious person uses the train.

Additionally, the suspicious terminal information storage unit 182 stores the position and the time at which a suspicious terminal stopped being detected.

A user can refer to the position and the time at which the suspicious terminal stopped being detected and thereby obtain information regarding activity patterns of the suspicious person, allowing the contemplation of measures to be taken against the suspicious person. For example, if the user is riding a train and the position at which the radio waves were last detected is a station, then the suspicious person can be considered to have disembarked from the train at that station. In this case, the user can take the measure of using a train on another line for the section over which the suspicious person uses the train.

### Second Embodiment

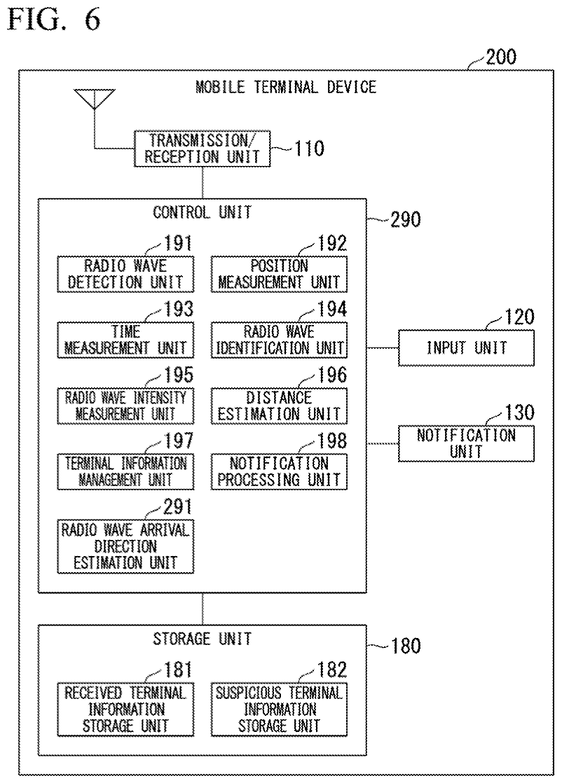

FIG. 6 is a schematic block diagram indicating an example of the functional configuration of a mobile terminal device according to the second embodiment. In the configuration indicated in FIG. 6, a mobile terminal device 200 comprises a transmission/reception unit 110, an input unit 120, a notification unit 130, a storage unit 180, and a control unit 290. The storage unit 180 comprises a received terminal information storage unit 181 and a suspicious terminal information storage unit 182. The control unit 290 comprises a radio wave detection unit 191, a position measurement unit 192, a time measurement unit 193, a radio wave identification unit 194, a radio wave intensity measurement unit 195, a distance estimation unit 196, a terminal information management unit 197, a notification processing unit 198, and a radio wave arrival direction estimation unit 291.

The respective units in FIG. 6 corresponding to units in FIG. 1 and having similar functions thereto are assigned the same reference numbers (110, 120, 130, 180, 181, 182, 191, 192, 193, 194, 195, 196, 197, and 198), and their descriptions are omitted.

The mobile terminal device 200 is different from the mobile terminal device 100 (FIG. 1) in that the control unit 290 comprises a radio wave arrival direction estimation unit 291. Aside therefrom, the mobile terminal device 200 is similar to the mobile terminal device 100.

The radio wave arrival direction estimation unit 291 estimates the arrival directions of radio waves from the individual mobile terminal devices. In particular, the radio wave arrival direction estimation unit 291 estimates the directions of arrival of the radio waves from suspicious terminals.

A suspicious person can be expected to be in the direction estimated by the radio wave arrival direction estimation unit 291. The user can refer to the direction estimated by the radio wave arrival direction estimation unit 291 and take measures against the suspicious person. For example, if the user has not yet encountered the suspicious person, then the possibility of encountering the suspicious person can be reduced by avoiding the direction estimated by the radio wave arrival direction estimation unit 291. Alternatively, if the user is pursuing a harasser such as a groping suspect, then the possibility of finding the harasser can be made higher by pursuing the harasser in the direction estimated by the radio wave arrival direction estimation unit 291.

The radio wave arrival direction estimation unit 291 may use an array antenna to estimate the radio wave arrival direction. Alternatively, the radio wave arrival direction estimation unit 291 may use a single directional antenna to detect the radio wave arrival states from the directions in which the user has oriented the antenna. By the user orienting the antenna in various directions, the radio wave arrival direction estimation unit 291 can, for example, estimate a direction in which the radio wave reception intensity is the strongest to be the radio wave arrival direction. In this case, the radio wave arrival direction estimation unit 291 may measure the direction in which the antenna is oriented by comprising a gyrocompass or the like, and may detect the direction in which the radio wave reception intensity is the strongest.

The transmission/reception unit 110 may comprise an array antenna or a single directional antenna, and the radio wave arrival direction measurement unit 291 may use the antenna in the transmission/reception unit 110. Alternatively, the radio wave arrival direction estimation unit 291 may comprise an antenna separate from the antenna in the transmission/reception unit 110.

Additionally, the notification unit 130 may display the radio wave arrival direction. Alternatively, the notification unit 130 may indicate the radio wave arrival direction by sound, such as by outputting a sound with a volume corresponding to the radio wave reception intensity in the direction, in accordance with the direction in which the user orients the antenna.

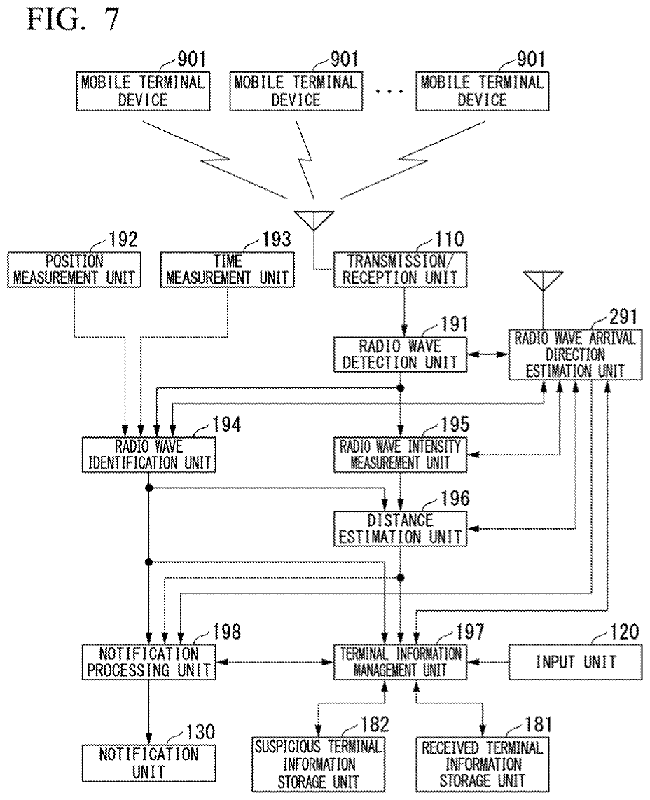

FIG. 7 is a diagram indicating an example of the input and the output of data in the units in the mobile terminal device 200. FIG. 7 differs from FIG. 3 in that the radio wave arrival direction estimation unit 291 is indicated. Otherwise, the example in FIG. 7 is similar to that in the case of FIG. 3.

The radio wave arrival direction estimation unit 291 performs a process by making use of the functions of the other units. Specifically, the radio wave arrival direction estimation unit 291 makes use of the functions of the radio wave detection unit 191 to detect the radio waves from individual mobile terminal devices, from among the received radio waves. Furthermore, the radio wave arrival direction estimation unit 291 makes use of the functions of the radio wave intensity measurement unit 195 to measure the reception intensities of the radio waves from the individual mobile terminal devices. Additionally, the radio wave arrival direction estimation unit 291 makes use of the functions of the radio wave identification unit 194 to extract, from among the radio waves from the individual mobile terminal devices, identification information in accordance with the mobile terminal devices that are the transmission sources. Alternatively, the radio wave arrival direction estimation unit 291 may have functions similar to the functions of these units.

Furthermore, the radio wave arrival direction estimation unit 291 refers to the suspicious terminal information via the terminal information management unit 197 and detects radio waves from suspicious terminals among the radio waves from the individual mobile terminal devices. The radio wave arrival direction estimation unit 291 generates information indicating the intensities of the radio waves from the suspicious terminals by associating the intensities of the detected radio waves with the identification information extracted from those radio waves.

The radio wave arrival direction estimation unit 291 acquires information indicating the intensity of radio waves from a suspicious terminal in each direction by repeating the process for each radio wave arrival direction. The radio wave arrival direction estimation unit 291 detects the direction in which the radio waves from the suspicious terminal is the strongest based on the acquired information.

The radio wave arrival direction estimation unit 291 outputs the detected direction to the notification processing unit 198 as the direction of arrival of the radio waves from the suspicious terminal. The notification processing unit 198 controls the notification unit 130 and notifies the user of the direction of arrival of the radio waves from the suspicious terminal.

As described above, the radio wave arrival direction estimation unit 291 estimates the direction of arrival of radio waves from the suspicious terminal.

A suspicious person can be expected to be in the direction estimated by the radio wave arrival direction estimation unit 291, and the user can refer to the direction estimated by the radio wave arrival direction estimation unit 291 to take measures against the suspicious person. For example, if the user has not yet encountered the suspicious person, then the possibility of encountering the suspicious person can be reduced by avoiding the direction estimated by the radio wave arrival direction estimation unit 291. Alternatively, if the user is pursuing a harasser such as a groping suspect, then the possibility of finding the harasser can be made higher by pursuing the harasser in the direction estimated by the radio wave arrival direction estimation unit 291.

### Third Embodiment

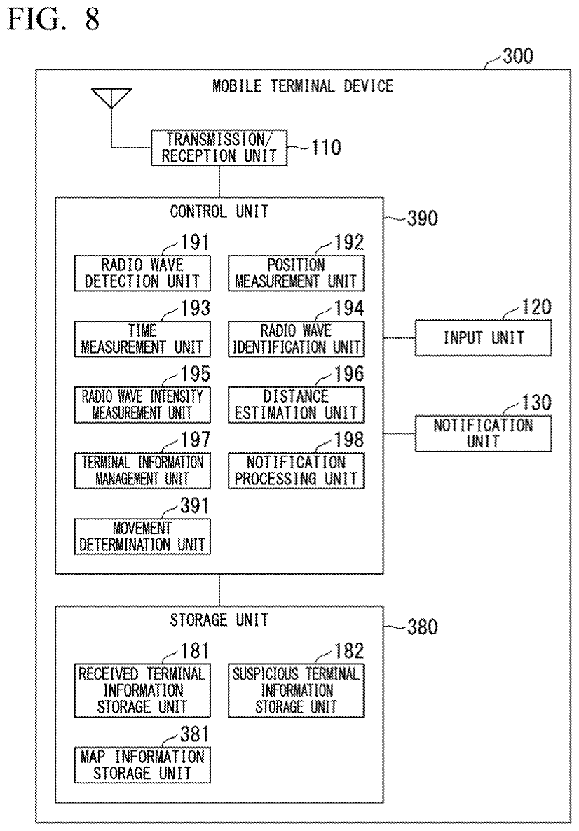

FIG. 8 is a schematic block diagram indicating an example of the functional configuration of a mobile terminal device according to the third embodiment. In the configuration indicated in FIG. 8, a mobile terminal device 300 comprises a transmission/reception unit 110, an input unit 120, a notification unit 130, a storage unit 380, and a control unit 390. The storage unit 380 comprises a received terminal information storage unit 181, a suspicious terminal information storage unit 182, and a map information storage unit 381. The control unit 390 comprises a radio wave detection unit 191, a position measurement unit 192, a time measurement unit 193, a radio wave identification unit 194, a radio wave intensity measurement unit 195, a distance estimation unit 196, a terminal information management unit 197, a notification processing unit 198, and a movement determination unit 391.

The respective units in FIG. 8 corresponding to units in FIG. 1 and having similar functions thereto are assigned the same reference numbers (110, 120, 130, 181, 182, 191, 192, 193, 194, 195, 196, 197, and 198), and their descriptions are omitted.

The mobile terminal device 300 is different from the mobile terminal device 100 (FIG. 1) in that the storage unit 380 comprises a map information storage unit 381 and the control unit 390 comprises a movement determination unit 391. Aside therefrom, the mobile terminal device 300 is similar to the mobile terminal device 100.

The map information storage unit 381 stores map information. The map information mentioned here is information indicating what location of the current position of the mobile terminal device 300 is, such as that the mobile terminal device 300 is located in a station.

The movement determination unit 391 determines whether or not the same mobile terminal device was detected before and after movement of the user's mobile terminal device 300 based on the position of the user's mobile terminal device 300 measured by the position measurement unit 192 and the distances to other mobile terminal devices estimated by the distance estimation unit 196. Specifically, the movement determination unit 391 determines whether or not the transmission/reception unit 110 received radio waves from the same mobile terminal device before and after movement of the user's mobile terminal device 300.

Alternatively, the notification processing unit 198 may determine whether or not the same mobile terminal device was detected before and after movement of the user's mobile terminal device 300 by acquiring, from the movement determination unit 391, information regarding movement states of the user's mobile terminal device 300.

In order for the movement determination unit 391 to detect movement of the user's mobile terminal device 300, the storage unit 380 may store position history information of the mobile terminal device 300 measured by the position measurement unit 192. The movement determination unit 391 can detect movement of the mobile terminal device 300 by detecting changes in the position of the mobile terminal device 300 on the basis of the history information.

In the case in which the movement determination unit 391 has detected the same mobile terminal device before and after the movement of the user's mobile terminal device 300, that mobile terminal device can be considered to be moving together with the mobile terminal device 300. There is a high likelihood that this mobile terminal device is a mobile terminal device of a harasser, such as the mobile terminal device of a stalker who is persistently following the user.

Therefore, if the movement determination unit 391 detects the same mobile terminal device before and after movement of the user's mobile terminal device 300, then the notification unit 130 notifies the user of the determination results from the movement determination unit 391 in accordance with control by the notification processing unit 198. The determination results from the movement determination unit 391 mentioned here are determination results regarding whether or not the movement determination unit 391 detected the same mobile terminal device before and after movement of the user's mobile terminal device 300.

For example, if the movement determination unit 391 has determined that the same mobile terminal device was detected before and after movement of the user's mobile terminal device 300, then the notification unit 130 notifies the user that a suspicious terminal has been detected.

However, if the user is riding a vehicle such as a train, then the mobile terminal devices of passengers on the same train will move similarly to the mobile terminal device 300 (the user's mobile terminal device). In this case, the movement determination unit 391 could mis-detect the mobile terminal devices of passengers on the same train as being suspicious terminals.

Therefore, the movement determination unit 391 determines the movement means by calculating the movement speed on the basis of the position difference (amount of change) of the user's mobile terminal device 300 and the time difference. If the movement speed is at least a threshold value (for example, 30 km/h), then the movement determination unit 391 determines that the user is moving on a railway, a bus, or the like. However, if the movement speed is not more than the movement speed, then the movement determination unit 391 determines that the user is moving on foot. Also, the movement determination unit 391 detects cases in which the user moves to a different car on foot while the train is stopped at a station, based on the movement speed and the map information.

The notification of determination results from the movement determination unit 391 to the user may be suspended while the user is moving by riding a vehicle.

For example, if the notification processing unit 198 refers to the map information and the mobile terminal device 300 is located on a railway line outside a station, then the notification of determination results from the movement determination unit 391 to the user may be suspended.

On the other hand, in the case in which a train or the like ridden by the user is stopped at a station, if there is a person who moves together with the user when the user moves to another car, then there is a high likelihood that the person is a harasser such as a stalker. Therefore, the movement determination unit 391 refers to the map information and the determination results from the movement means, and determines whether or not the mobile terminal device 300 is located in the station. If the movement determination unit 391 determines that the mobile terminal device 300 is located in a station, then the notification processing unit 198 may control the notification unit 130 so as to notify the user of the determination results by the movement determination unit 391.

However, the method by which the notification processing unit 198 decides whether or not to notify the user of the determination results by the movement determination unit 391 is not limited to the method of referring to map information. For example, the mobile terminal device 300 may comprise a velocity sensor, and if the mobile terminal device 300 is moving at a velocity that is at least a prescribed velocity, then the notification processing unit 198 may suspend the notification of determination results from the movement determination unit 391 to the user.

For example, when a notification has been received from the user indicating that an incident has occurred and the mobile terminal device 300 has detected a suspicious terminal, if there are many mobile terminal devices detected as suspicious terminals, then the movement determination unit 391 may be used as a filter to narrow down suspicious terminals. Specifically, among the mobile terminal devices detected as suspicious terminals by the mobile terminal device 300, the movement determination unit 391 may leave only the mobile terminal devices detected either before or after movement of the mobile terminal device 300 as suspicious terminals, excluding other mobile terminal devices from among the suspicious terminals.

Alternatively, if a mobile terminal device that the mobile terminal device 300 detected as a suspicious terminal is detected even after the movement determination unit 391 detects movement of the mobile terminal device 300, then the user can be considered to be persistently followed by a harasser. In this case, the notification processing unit 198 can control the notification unit 130 to provide a notification urging the user to be particularly cautious.

Alternatively, in the case in which the movement determination unit 391 has detected the same mobile terminal device before and after movement of the mobile terminal device 300 in a state before the input unit 120 has received a notification from the user indicating that an incident has occurred, the notification unit 130 may notify the user that a suspicious terminal has been detected in accordance with control by the notification processing unit 198. In this case, the movement determination unit 391 can detect, as suspicious terminals, even mobile terminal devices other than the mobile terminal devices that are registered as suspicious terminals in the suspicious terminal information storage unit 182.

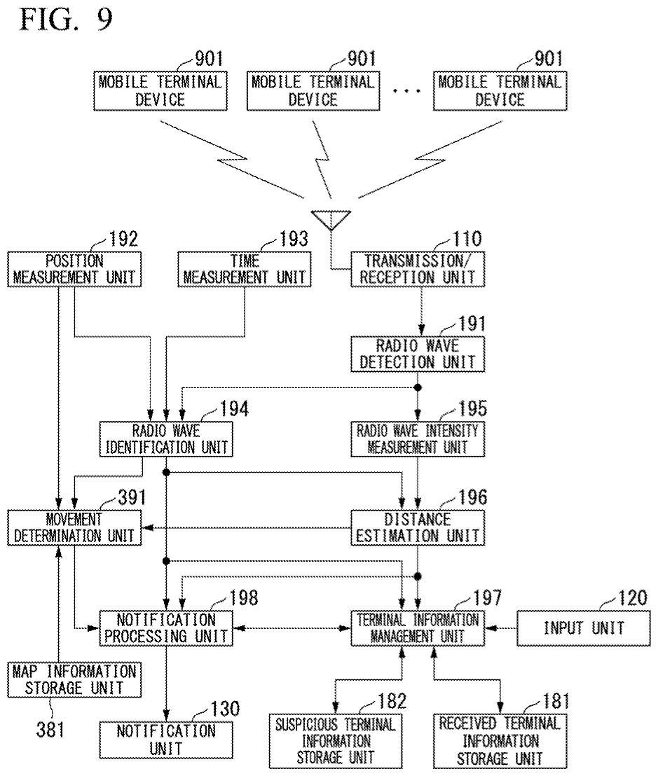

FIG. 9 is a diagram indicating an example of the input and output of data in the units in the mobile terminal device 300. FIG. 9 differs from FIG. 3 in that the movement determination unit 391 and the map information storage unit 381 are indicated. Otherwise, the example in FIG. 7 is similar to that in the case of FIG. 3.

The movement determination unit 391 uses history information regarding the position of the mobile terminal device 300 measured by the position measurement unit 192 to detect movement of the mobile terminal device 300. Furthermore, the movement determination unit 391 uses the identification information extracted from the radio waves of individual mobile terminal devices by the radio wave identification unit 194 and the estimated distances to the mobile terminal devices that are transmission sources estimated by the distance estimation unit 196 to determine whether or not the same mobile terminal device has been detected before and after movement of the mobile terminal device 300.

If the movement determination unit 391 has detected the same mobile terminal device before and after movement of the mobile terminal device 300, then the notification processing unit 198 controls the notification unit 130 to notify the user that a suspicious terminal has been detected.

The movement determination unit 391 or the notification processing unit 198 may refer to map information in the map information storage unit 381, and if the mobile terminal device 300 is moving in a vehicle, then the notification of the determination results of the movement determination unit 391 to the user may be suspended.

As described above, the movement determination unit 391 determines whether or not the same mobile terminal device has been detected within a prescribed distance before and after movement of the mobile terminal device 300 based on the position of the mobile terminal device 300 and the distances from other mobile terminal devices. If the movement determination unit 391 determines that the same mobile terminal device has been detected within the prescribed distance before and after movement of the mobile terminal device 300, then the notification unit 130 notifies the user of the determination result.

As a result thereof, aside from the condition that the transmission/reception unit 110 receives radio waves when a notification from the user is received indicating that an incident has occurred, the mobile terminal device 300 can also detect a suspicious terminal by using the condition that the same mobile terminal device has been detected within a prescribed distance before and after movement of the mobile terminal device 300.

By the mobile terminal device 300 using more conditions to detect suspicious terminals, the following matters are possible. Specifically, as mentioned above, various manners of operation are possible, such as to narrow down the suspicious terminals, to provide the user with an extra level of warning, and to detect suspicious terminals outside a timing at which a notification is received from the user indicating that an incident has occurred.

### <Example of Configuration of Embodiments>

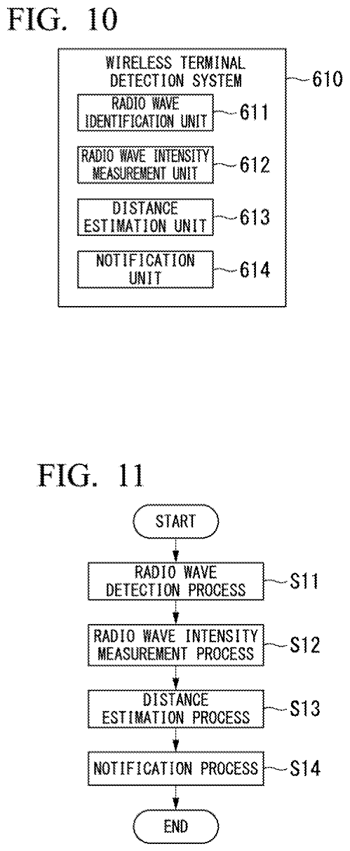

Next, an example of a configuration of an embodiment will be described by referring to FIG. 10 and FIG. 11. FIG. 10 is a diagram indicating an example of the configuration of a wireless terminal detection system according to an embodiment. In the configuration indicated in FIG. 10, the wireless terminal detection system 610 comprises a radio wave identification unit 611, a radio wave intensity measurement unit 612, a distance estimation unit 613, and a notification unit 614.

In this configuration, the radio wave identification unit 611 extracts identification information in accordance with the wireless terminals that are the transmission sources from the radio waves from individual wireless terminals detected from among the received radio waves. The radio wave intensity measurement unit 612 measures the intensities of the radio waves from the individual wireless terminals. The distance estimation unit 613 estimates the attenuation rate of the radio wave intensities with respect to distance based on the number of mobile terminal devices that are radio wave transmission sources detected from among the received radio waves, and estimates the distances to the individual mobile terminal devices based on the estimated attenuation rate. In the case in which, based on the aforementioned identification information, a wireless terminal that is the radio wave transmission sources is determined to be registered as a suspicious wireless terminal and the estimated distance to the wireless terminal that is the radio wave transmission sources is determined to be not more than a prescribed distance, the notification unit 614 notifies the user that a suspicious wireless terminal has been detected.

As a result thereof, the wireless terminal detection system 610 can make the estimated distance reflect the states in the environs when estimating the distance to a wireless terminal that is to be detected. In particular, according to the wireless terminal detection system 610, the estimated distance can be made to reflect the states of attenuation of radio waves due to people in the environs of the wireless terminal detection system 610, and due to this feature, the distance from a wireless terminal to be detected can be estimated with higher precision.

FIG. 11 is a diagram indicating an example of a processing procedure in a wireless terminal detection method according to an embodiment.

In the process in FIG. 11, a radio wave identification process (step S11) involves extracting identification information in accordance with the wireless terminals that are the transmission sources from the radio waves from individual wireless terminals detected from among the received radio waves. A radio wave intensity measurement process (step S12) involves measuring the intensities of the radio waves from the individual wireless terminals. A distance estimation process (step S13) involves estimating the attenuation rate of the radio wave intensities relative to the distance based on the number of wireless terminals that are radio wave transmission sources detected from among the received radio waves, and estimating the distances to the individual wireless terminals based on the estimated attenuation rate. A notification process (step S14) involves notifying the user that a suspicious wireless terminal has been detected when it is determined, based on the identification information, that a wireless terminal that is a radio wave transmission source is registered as a suspicious wireless terminal, and that the estimated distance to the wireless terminal that is that radio wave transmission source is not more than a prescribed distance.

According to the process in FIG. 11, when estimating the distance from a wireless terminal to be detected, the estimated distance can be made to reflect the states in the environs. In particular, according to the process in FIG. 11, the states of attenuation of radio waves due to people in the environs can be reflected in the estimated distance, and due to this feature, the distance from a wireless terminal to be detected can be estimated with higher precision.

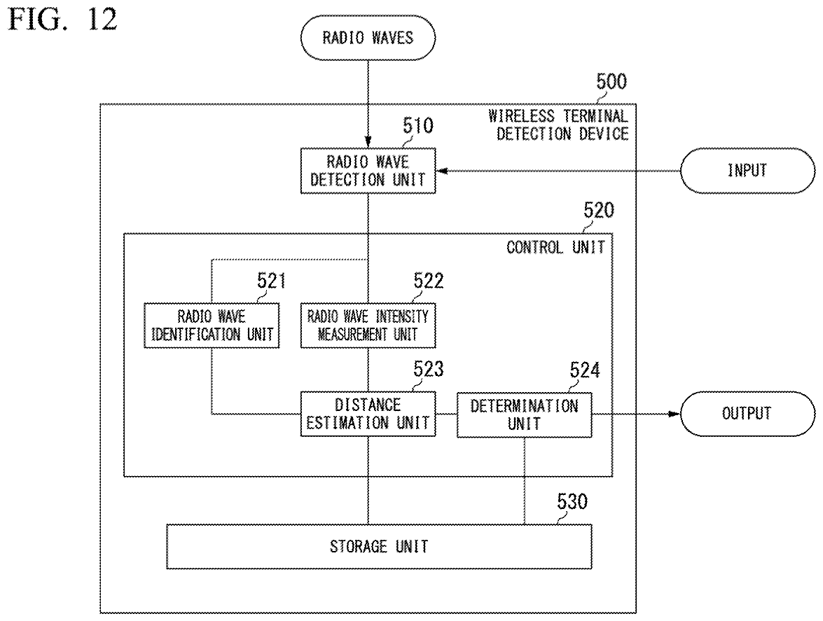

FIG. 12 is a diagram indicating an example of the configuration of a wireless terminal detection device according to an embodiment. In the configuration indicated in FIG. 12, a wireless terminal detection device 500 comprises a radio wave detection unit 510, a control unit 520, and a storage unit 530. The control unit 520 comprises a radio wave identification unit 521, a radio wave intensity measurement unit 522, a distance estimation unit 523, and a determination unit 524.

In this configuration, the radio wave detection unit 510, upon receiving an instruction such as a user operation, detects radio waves transmitted from individual wireless terminals from among the radio waves received via an antenna or the like.

The radio wave identification unit 521 identifies individual wireless terminals from among the radio waves from the individual wireless terminals detected by the radio wave detection unit 510. Specifically, the radio wave identification unit 521 extracts identification information identifying the wireless terminals from the individual wireless terminals detected by the radio wave detection unit 510.

The radio wave intensity measurement unit 522 measures the reception intensities of the radio waves from the individual wireless terminals detected by the radio wave detection unit 510.

The distance estimation unit 523 estimates the distances to individual wireless terminals associated with the identification information for each wireless terminal on the basis of the identification information of the individual wireless terminals identified by the radio wave identification unit 521 and the reception intensities of the radio waves from the individual wireless terminals measured by the radio wave intensity measurement unit 522.

The storage unit 530 stores the identification information of the wireless terminals that the distance estimation unit 523 has estimated to be within a certain distance. The wireless terminals of which identification information is stored by the storage unit 530 correspond to suspicious terminal candidates.

The determination unit 524 collates the identification information of the wireless terminals newly estimated to be within a certain distance by the distance estimation unit 523 with the identification information of wireless terminals that are already stored in the storage unit 530, and determines whether or not there is any matching identification information. Furthermore, the determination unit 524 outputs (provides a notification of) the determination results thereof. The terminals in which the wireless terminals that the determination unit 524 has determined to have matching identification information are treated as suspicious terminal candidates. The output may be performed by means of a screen display, by lighting a lamp, by outputting audio, or the like.

According to the wireless terminal detection device 500, the estimated distance can be made to reflect the states in the environs when estimating the distance to a wireless terminal that is to be detected. In particular, according to the wireless terminal detection device 500, the estimated distance can be made to reflect the states of attenuation of radio waves due to people in the environs of the wireless terminal detection device 500, and due to this feature, the distance from a wireless terminal to be detected can be estimated with higher precision.

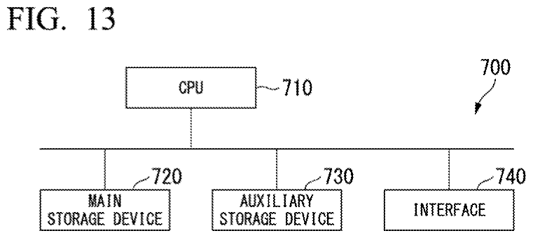

FIG. 13 is a schematic block diagram indicating the configuration of a computer according to at least one embodiment.

In the configuration indicated in FIG. 13, a computer 700 comprises a CPU 710, a main storage device 720, an auxiliary storage device 730, and an interface 740.

Any one or more of the above-mentioned mobile terminal device 100, the mobile terminal device 200, the mobile terminal device 300, the wireless terminal detection device 500, or the wireless terminal detection system 610 may be implemented in the computer 700. In that case, the operations in the above-mentioned processing units are stored, in the form of a program, in the auxiliary storage device 730. The CPU 710 reads the program from the auxiliary storage device 730, loads the program in the main storage device 720, and executes the above-mentioned processes in accordance with the program. Additionally, the CPU 710 secures, in the main storage device 720, storage areas corresponding to the above-mentioned storage units in accordance with the program. Communication between the respective devices and other devices are executed by the interface 740 having a communication function and communicating in accordance with control by the CPU 710.

In the case in which the mobile terminal device 100 is implemented on the computer 700, the operations of the control unit 190 and the respective units therein are stored in the auxiliary storage device 730 in the form of a program. The CPU 710 reads the program from the auxiliary storage device 730, loads the program in the main storage device 720, and executes the above-mentioned processes in accordance with the program.

Additionally, the CPU 710 secures, in the main storage device 720, storage areas corresponding to the storage unit 180 and the respective units therein in accordance with the program.

Communication by the transmission/reception unit 110 is executed by the interface 740 having a communication function and communicating in accordance with control by the CPU 710. The processes in the input unit 120 are executed by the interface 740 having an input device and receiving notifications by user operations. The operations in the notification unit 130 are executed by the interface 740 having a notification function such as, for example, a display function, and providing notifications in accordance with control by the CPU 710.

In the case in which the mobile terminal device 200 is implemented on the computer 700, the operations of the control unit 290 and the respective units therein are stored in the auxiliary storage device 730 in the form of a program. The CPU 710 reads the program from the auxiliary storage device 730, loads the program in the main storage device 720, and executes the above-mentioned processes in accordance with the program.

Additionally, the CPU 710 secures, in the main storage device 720, storage areas corresponding to the storage unit 180 and the respective units therein in accordance with the program.

Communication by the transmission/reception unit 110 is executed by the interface 740 having a communication function and communicating in accordance with control by the CPU 710. The processes in the input unit 120 are executed by the interface 740 having an input device and receiving notifications by user operations. The operations in the notification unit 130 are executed by the interface 740 having a notification function such as, for example, a display function, and providing notifications in accordance with control by the CPU 710.

In the case in which the mobile terminal device 300 is implemented on the computer 700, the operations of the control unit 390 and the respective units therein are stored in the auxiliary storage device 730 in the form of a program. The CPU 710 reads the program from the auxiliary storage device 730, loads the program in the main storage device 720, and executes the above-mentioned processes in accordance with the program.

Additionally, the CPU 710 secures, in the main storage device 720, storage areas corresponding to the storage unit 380 and the respective units therein in accordance with the program.

Communication by the transmission/reception unit 110 is executed by the interface 740 having a communication function and communicating in accordance with control by the CPU 710. The processes in the input unit 120 are executed by the interface 740 having an input device and receiving notifications by user operations. The operations in the notification unit 130 are executed by the interface 740 having a notification function such as, for example, a display function, and providing notifications in accordance with control by the CPU 710.

In the case in which the wireless terminal detection device 500 is implemented on the computer 700, the operations of the control unit 520 and the respective units therein are stored in the auxiliary storage device 730 in the form of a program. The CPU 710 reads the program from the auxiliary storage device 730, loads the program in the main storage device 720, and executes the above-mentioned processes in accordance with the program.

Additionally, the CPU 710 secures, in the main storage device 720, storage areas corresponding to the storage unit 530 and the respective units therein in accordance with the program.

The reception of radio waves by the radio wave detection unit 510 is executed by the interface 740 having a radio wave reception function, and receiving and processing radio waves in accordance with control by the CPU 710. The reception of inputs by the radio wave detection unit 510 is executed by the interface 740 having an input device and receiving notifications by user operations. The outputs by the determination unit 524 are executed by the interface 740 having a notification function such as, for example, a display function, and providing notifications in accordance with control by the CPU 710.

In the case in which the wireless terminal detection system 610 is implemented on the computer 700, the operations of the radio wave identification unit 611, the radio wave intensity measurement unit 612, and the distance estimation unit 613 are stored in the auxiliary storage device 730 in the form of a program. The CPU 710 reads the program from the auxiliary storage device 730, loads the program in the main storage device 720, and executes the above-mentioned processes in accordance with the program.

Additionally, the operations of the notification unit 614 are executed by the interface 740 having a notification function such as, for example, a display function, and providing notifications in accordance with control by the CPU 710.

A program for realizing all or some of the functions of the mobile terminal device 100, the mobile terminal device 200, the mobile terminal device 300, or the wireless terminal detection system 610 may be recorded on a computer-readable recording medium, and the program recorded on this recording medium may be read into and executed by a computer system to perform the processes of the respective units. The “computer system” mentioned here includes an OS (operating system) and hardware such as peripheral devices.

The “computer-readable recording medium” refers to a portable medium such as a flexible disk, a magneto-optic disk, a ROM (Read-Only Memory), a CD-ROM (Compact Disc Read-Only Memory), or the like, or to a storage device such as a hard disk internal to a computer system. Additionally, the above-mentioned program may be for realizing some of the aforementioned functions, and furthermore, the aforementioned functions may be realized by being combined with a program already recorded in the computer system.

While embodiments of the present invention have been explained in detail with reference to the drawings above, the specific configurations are not limited to those in these embodiments, and design modifications and the like within a range not departing from the spirit of the present invention are included.

The present application claims the benefit of priority based on Japanese Patent Application No. 2019-130410, filed Jul. 12, 2019, the entire disclosure of which is incorporated herein by reference.

### INDUSTRIAL APPLICABILITY

According to the present invention, when estimating the distance to a wireless terminal to be detected, the distance to the wireless terminal to be detected can be more accurately estimated by reflecting the states in the environs of the distance being estimated.

### REFERENCE SIGNS LIST

100, 200, 300 Mobile terminal device
110 Transmission/reception unit
120 Input unit
130, 614 Notification unit
180, 380, 530 Storage unit
181 Received terminal information storage unit
182 Suspicious terminal information storage unit
190, 290, 390, 520 Control unit
191, 510 Radio wave detection unit
192 Position measurement unit
193 Time measurement unit
194, 521, 611 Radio wave identification unit
195, 522, 612 Radio wave intensity measurement unit
196, 523, 613 Distance estimation unit
197 Terminal information management unit
198 Notification processing unit
291 Radio wave arrival direction estimation unit
381 Map information storage unit
391 Movement determination unit
500 Wireless terminal detection device
524 Determination unit
610 Wireless terminal detection system

What is claimed is:

1. A wireless terminal detection system comprising:
at least one memory configured to store instructions; and
at least one processor configured to execute the instructions to:
extract, from radio waves from individual wireless terminals detected from among received radio waves, identification information in accordance with the wireless terminals that are transmission sources;
measure radio wave intensities of the radio waves from the individual wireless terminals;
estimate an attenuation rate of the radio wave intensities with respect to distance based on a number of the wireless terminals that are radio wave transmission sources detected from among the received radio waves, and estimate distances to the individual wireless terminals based on the estimated attenuation rate; and
notify a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

2. The wireless terminal detection system according to claim 1, wherein the at least one processor is configured to execute the instructions to estimate the attenuation rate based on the number of the wireless terminals that are radio wave transmission sources detected from among the received radio waves, and the radio wave intensities of the radio waves from the individual wireless terminals.

3. The wireless terminal detection system according to claim 1, wherein the at least one processor is configured to execute the instructions to notify the user that the suspicious wireless terminal has been detected, and the estimated distance to the suspicious wireless terminal.

4. The wireless terminal detection system according to claim 1, wherein the at least one processor is configured to execute the instructions to notify the user that the suspicious wireless terminal has been detected, and of history information regarding detection of the suspicious wireless terminal in the past.

5. The wireless terminal detection system according to claim 1, wherein the at least one memory is configured to store a position and a time at which the suspicious wireless terminal started being detected.

6. The wireless terminal detection system according to claim 5, wherein the at least one memory is further configured to store a position and a time at which the suspicious wireless terminal stopped being detected.

7. The wireless terminal detection system according to claim 1, wherein the at least one processor is further configured to execute the instructions to estimate a direction of arrival of radio waves from the suspicious wireless terminal.

8. The wireless terminal detection system according to claim 1, wherein
the at least one processor is further configured to execute the instructions to determine whether the same wireless terminal has been detected within a prescribed distance before and after movement of the user's wireless terminal based on the positions of the user's wireless terminal and the distances thereof from the other wireless terminal, and
the at least one processor is further configured to execute the instructions to notify, if it is determined that the same wireless terminal has been detected before and after movement of the user's wireless terminal, the user of the determination result.

9. A wireless terminal detection method comprising:
extracting, from radio waves from individual wireless terminals detected from among received radio waves, identification information in accordance with the wireless terminals that are transmission sources;
measuring radio wave intensities of the radio waves from the individual wireless terminals;
estimating an attenuation rate of the radio wave intensities with respect to distance based on a number of the wireless terminals that are radio wave transmission sources detected from among the received radio waves, and estimating distances to the individual wireless terminals based on the estimated attenuation rate; and
notifying a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

10. A non-transitory computer-readable storage medium storing a program for making a computer execute processes for:
extracting, from radio waves from individual wireless terminals detected from among received radio waves, identification information in accordance with the wireless terminals that are transmission sources;
measuring radio wave intensities of the radio waves from the individual wireless terminals;
estimating an attenuation rate of the radio wave intensities with respect to distance based on a number of the wireless terminals that are radio wave transmission sources detected from among the received radio waves, and estimating distances to the individual wireless terminals based on the estimated attenuation rate; and
notifying a user that a suspicious wireless terminal has been detected if, based on the identification information, a wireless terminal among the radio wave transmission sources is determined to be registered as a suspicious wireless terminal, and the estimated distance to the wireless terminal among the radio wave transmission sources is not more than a prescribed distance.

11. The wireless terminal detection method according to claim 9, wherein the estimating of the attenuation rate includes estimating the attenuation rate based on the number of the wireless terminals that are radio wave transmission sources detected from among the received radio waves, and the radio wave intensities of the radio waves from the individual wireless terminals.

12. The wireless terminal detection method according to claim 9, wherein the notifying includes notifying the user that the suspicious wireless terminal has been detected, and the estimated distance to the suspicious wireless terminal.

13. The wireless terminal detection method according to claim 9, wherein the notifying includes notifying the user that the suspicious wireless terminal has been detected, and of history information regarding detection of the suspicious wireless terminal in the past.

14. The wireless terminal detection method according to claim 9, further comprising storing a position and a time at which the suspicious wireless terminal started being detected.

15. The wireless terminal detection method according to claim 14, wherein the storing include storing a position and a time at which the suspicious wireless terminal stopped being detected.

16. The wireless terminal detection method according to claim 9, further comprising estimating a direction of arrival of radio waves from the suspicious wireless terminal.

17. The wireless terminal detection method according to claim 9, further comprising determining whether the same wireless terminal has been detected within a prescribed distance before and after movement of the user's wireless terminal based on the positions of the user's wireless terminal and the distances thereof from the other wireless terminal,
wherein the notifying includes notifying, if it is determined that the same wireless terminal has been detected before and after movement of the user's wireless terminal, the user of the determination result.
